(19) United States
(12) Patent Application Publication
(10) Pub. No.: US 2018/0242768 A1
(43) Pub. Date: Aug. 30, 2018

(54) SECURE DELIVERY STORAGE METHOD AND SYSTEM

(71) Applicant: CHESTER IP PTY LTD, NEW SOUTH WALES (AU)

(72) Inventor: MALCOLM LEWIS, NEW SOUTH WALES (AU)

(21) Appl. No.: 15/753,373

(22) PCT Filed: Aug. 19, 2016
(86) PCT No.: PCT/AU2016/050766

§ 371 Date: Feb. 19, 2018

(30) Foreign Application Priority Data
Aug. 19, 2015 (AU) 2015903352

(51) Int. Cl. A47G 29/14; A47G 29/16; G06Q 10/08; G06Q 50/28

(52) U.S. Cl. CPC A47G 29/141; A47G 29/16; G07F 17/12; G06Q 50/28; G06Q 10/08

(57) ABSTRACT

Disclosed herein are a storage unit (250) and a secure delivery system (200) that uses such a storage unit. The storage unit (250) includes a plurality of compartments (254, 256) including at least one refrigerated compartment (256), wherein each refrigerated compartment (256) is associated with a thermostat and a cooling device. The storage unit (250) also includes a corresponding plurality of scales (258, 260), each compartment being associated with a scale, a communications module (262) for coupling to a communications network (205), at least one lid (820) for accessing the compartments (254, 256), and a lock adapted to secure each lid (820) in a closed position. The storage unit (250) further includes a control panel (810) for controlling the lock, wherein the control panel (810) has a user interface for receiving input from a user, and a power source for supplying power to the cooling device and the control panel. The control panel (810) is adapted to release the lock upon validating the received input against a code received by the communications module (262).

### RELATED APPLICATION

The present application is related to Australian Provisional Patent Application No. 2015903352, entitled “Secure delivery storage method and system” and filed on 19 Aug. 2015 in the name of Chester IP Pty Ltd, the entire content of which is incorporated by reference as if fully set forth herein.

### TECHNICAL FIELD

The present disclosure relates to a secure delivery storage method and system. In particular, the present invention relates to a secure delivery storage method and system that uses a lockable storage locker.

### BACKGROUND

Traditional retail transactions involve a customer entering a store, selecting an item to be purchased, and receiving the item in exchange for the agreed consideration. The consideration could be cash physically handed over to the merchant, electronic funds transfer or credit card payment effected using a point-of-sale (POS) terminal, or an agreed set of goods or services.

Some merchants also publish printed catalogues, which are distributed to subscribers and/or sent to potential customers. Such printed catalogues include a list of available products and their associated prices and may additionally include photographs of the products and reviews. Depending on the merchant, the catalogue may include an ordering form to be completed and returned with payment by the customer. Alternatively or additionally, the merchant may receive purchase orders by telephone or, more recently, by email. On receipt of an order and the accompanying payment, the merchant arranges delivery of the ordered goods.

In more recent times, online shopping has provided customers with greater flexibility and range of available goods. Most merchants now operate websites hosted on servers connected to the Internet, wherein the websites enable the customer to browse a range of available goods, add one or more selected goods to a virtual shopping cart, and then provide payment and a delivery address. The merchant then arranges delivery of the ordered goods by a delivery agency to the nominated delivery address. The delivery agency is typically a postal service, courier company, or the merchant itself.

Online shopping has greatly increased the range of goods available to the average consumer and also provided various tools to enable the consumer to select the best available price. However, traditional delivery systems require someone to be present at the nominated delivery address at the time that the ordered goods are to be delivered. This can be extremely inconvenient, as often the delivery agency can only provide an approximate delivery window covering a number of hours during which the delivery will be made.

In many cases, the delivery agency does not provide tracking information or an estimated delivery date and time and consequently deliveries are frequently missed. In such cases, the goods to be delivered are often returned to a local depot from which the customer can pick up the goods or the delivery agency will try to deliver the goods at a later date. In other cases, the delivery agency may leave goods at a nominated delivery address in an unsecured location. This can expose the delivered goods to theft and/or exposure to the elements.

Some delivery agents require a signature from a recipient of delivered goods, to act as evidence of proof of delivery at a stated date and time to an address. The proof of delivery can be useful in preventing fraudulent claims from a recipient against a supplier or a delivery agency. Proof of delivery can be particularly important in relation to measuring delivery times for perishable goods, such as food.

Delivery storage lockers have recently been introduced by some delivery agencies or other providers. Australia Post, the postal service run by the Australian Government, provides parcel lockers at select locations for hire by customers. A customer hires the parcel locker from Australia Post and receives an address for an allocated parcel locker. The customer then uses the address of the postal locker as the delivery address for an online retail purchase. The delivery agency delivers the parcel to the parcel locker and the customer can pick up the parcel at any convenient time.

Such delivery storage lockers are only provided in a limited number of locations, which may not be convenient to all customers. Further, such storage lockers require the customer to use a delivery address different from the customer's home address and the delivery address may change, depending on availability of the same storage locker address.

The time taken to deliver and receive many types of ordered goods is not time critical. For example, the quality of the received product does not change for books and electronics, irrespective of the time taken to deliver those products. However, perishable goods can degrade or even be ruined if those goods are not handled in an appropriate manner at all steps in the delivery path. Some types of food can cause poisoning or even death if not transported and stored in appropriate conditions, such as being refrigerated at an appropriate temperature. As noted above, proof of delivery can be used to establish delivery times and ensure that those delivery times are within prescribed limits for the items being delivered.

In the case of foodstuffs and other products that are sensitive to temperature, humidity, or other climatic conditions, it is important to maintain a chain of custody from a supplier to a recipient. The chain of custody is an unbroken path from the supplier to a recipient or end customer, through any intervening distribution, delivery, and logistics agencies. A solid chain of custody minimises or prevents external interaction or interference with a product to be delivered, thus providing an end customer with a degree of confidence in the providence and quality of the delivered goods.

As noted above, some goods are perishable and/or susceptible to climatic conditions. Some such products require a cold chain, which is a temperature-controlled supply chain from a supplier to an end customer. A cold chain ensures a chain of custody within a prescribed temperature range. A cold chain is used to extend and ensure the shelf life of perishable goods, such as dairy products and seafood, along with pharmaceuticals and industrial chemicals.

Current storage lockers do not provide facilities for ensuring proof of delivery, a chain of custody, and a cold chain.

Thus, a need exists to provide an improved storage locker for receiving deliveries.

### SUMMARY

The present disclosure relates to a secure delivery storage method and system. The delivery method and system uses a lockage storage unit having at least one refrigerated storage compartment, wherein the storage unit is adapted to communicate with a remote server. The server regulates access to the storage unit by allocating a delivery access code to a delivery agency in relation to a purchase made by a user registered with a website associated with the server, wherein the user is associated with the storage unit to which the purchase is to be delivered.

In a first aspect, the present disclosure provides a storage unit comprising:

a plurality of compartments including at least one refrigerated compartment, said refrigerated compartment being associated with a thermostat and a cooling device;

a corresponding plurality of scales, each compartment being associated with a scale;

a communications module for coupling to a communications network;

at least one lid for accessing said compartments;

a lock adapted to secure each said lid in a closed position;

a control panel for controlling said lock, said control panel having a user interface for receiving input from a user; and

a power source for supplying power to said cooling device and said control panel;

wherein the control panel is adapted to release said lock upon validating said received input against a code received by said communications module.

In a second aspect, the present disclosure provides a secure delivery storage system, comprising:

a server adapted to host a website, said server including:
at least one processor;
a memory for storing user data relating to a set of registered users and website data relating to said website;
a logistics module for generating a delivery access code associated with a purchase made by one of said registered users; and
a server communications module coupled to a communications network for transmitting said delivery access code to a delivery agency; and

a storage unit for receiving a delivered product, said storage unit being associated with a registered user of said website, said storage unit including:
a first compartment;
first scales associated with said first compartment;
a storage unit communications module for coupling to said server communications module via said communications network;
a lid for accessing said first compartment;
a lock adapted to secure said lid in a closed position;
a control panel for controlling said lock, said control panel having a user interface for receiving said delivery access code; and
a power source for supplying power said control panel;
wherein said control panel releases said lock on receipt of said delivery access code, and
further wherein said storage unit communications module is adapted to transmit a delivery message to said website when said scales detect a delivery item in said first compartment.

According to another aspect, the present disclosure provides an apparatus for implementing any one of the aforementioned methods.

According to another aspect, the present disclosure provides a computer program product including a computer readable medium having recorded thereon a computer program for implementing any one of the methods described above.

Other aspects of the present disclosure are also provided.

### BRIEF DESCRIPTION OF THE DRAWINGS

One or more embodiments of the present disclosure will now be described by way of specific example(s) with reference to the accompanying drawings, in which:

FIG. 1 is a schematic representation illustrating flow of information in a secure delivery storage system of the present disclosure;

FIG. 2 is a schematic representation of a system on which one or more embodiments of the present disclosure may be practised;

FIG. 3 is a schematic block diagram representation of a system that includes a general purpose computer on which one or more embodiments of the present disclosure may be practised;

FIG. 4 is a schematic block diagram representation of a system that includes a general smartphone on which one or more embodiments of the present disclosure may be practised;

FIG. 5 is a flow diagram illustrating a method of purchasing a storage unit;

FIG. 6 is a flow diagram illustrating a method of purchasing an item in conjunction with a secure delivery storage system;

FIG. 7 is a flow diagram illustrating a method of delivering a purchased item to a secure storage unit;

FIGS. 8a, 8b, and 8c are schematic representations of a secure storage unit;

FIG. 9a is an introductory welcome screen of a graphical user interface adapted for use on a secure storage unit;

FIG. 9b is an alternative representation of the welcome screen of FIG. 9a;

FIG. 10a is a delivery screen of a graphical user interface adapted for use on a secure storage unit;

FIG. 10b is an alternative representation of the delivery screen of FIG. 10a;

FIG. 11a is a collection screen of a graphical user interface adapted for use on a secure storage unit;

FIG. 11b is an alternative representation of the collection screen of FIG. 11a;

FIG. 12 is an exit screen of a graphical user interface adapted for use on a secure storage unit; and

FIG. 13 is a representation of a personalised welcome screen displayed to a user upon having entered a correct owner access code.

### DETAILED DESCRIPTION

Method steps or features in the accompanying drawings that have the same reference numerals are to be considered to have the same function(s) or operation(s), unless the contrary intention is expressed or implied.

The present disclosure provides a secure delivery storage system that includes a website hosted on a computer server coupled to a communications network, such as the Internet. The server stores website data relating to the website and user data relating to a set of registered users, wherein each registered user is associated with a storage unit.

Each storage unit has at least one compartment, which can be used to store perishable goods. Further, each storage unit has a storage unit communications module for coupling the storage unit to a communications network, so as to communicate with the website. This enables the website to transmit delivery access codes to the storage unit so that a control module of the storage unit can validate an access code input by a delivery agent. The website is able to transmit multiple delivery access codes, corresponding to different deliveries and different users. Different users may be granted different access privileges, such as dates and/or times during which access is granted and permission to access different compartments of the storage unit, wherein the access privileges are controlled by the delivery access codes. When the control module validates an access code, the control module releases a lockable lid of the storage unit so as to allow the delivery agent to place goods in the one or more compartments.

Each compartment is associated with a scale that is able to determine receipt of a delivery to the respective compartment. Each scale is coupled to the control module and can provide the weight of a delivery to the control module. In some arrangements, a delivery access code provided by the website to the control module of the storage unit includes delivery information, such as the weight of the goods to be delivered. The control module is then able to compare the weight provided by the scale(s) to the delivery information to validate the content of a delivery. The delivery information may alternatively or additionally include other information, such as the temperature and dimensions of the goods to be delivered. This information can be used to validate the content of a delivery and, in certain applications, establish a cold chain for the delivered goods. Where the delivery information includes one or more nominated temperatures, the control module of the storage unit controls one or more thermostats in relation to one or more compartments of the storage unit so that the selected compartments are at the nominated temperature(s) by the time the delivery is made.

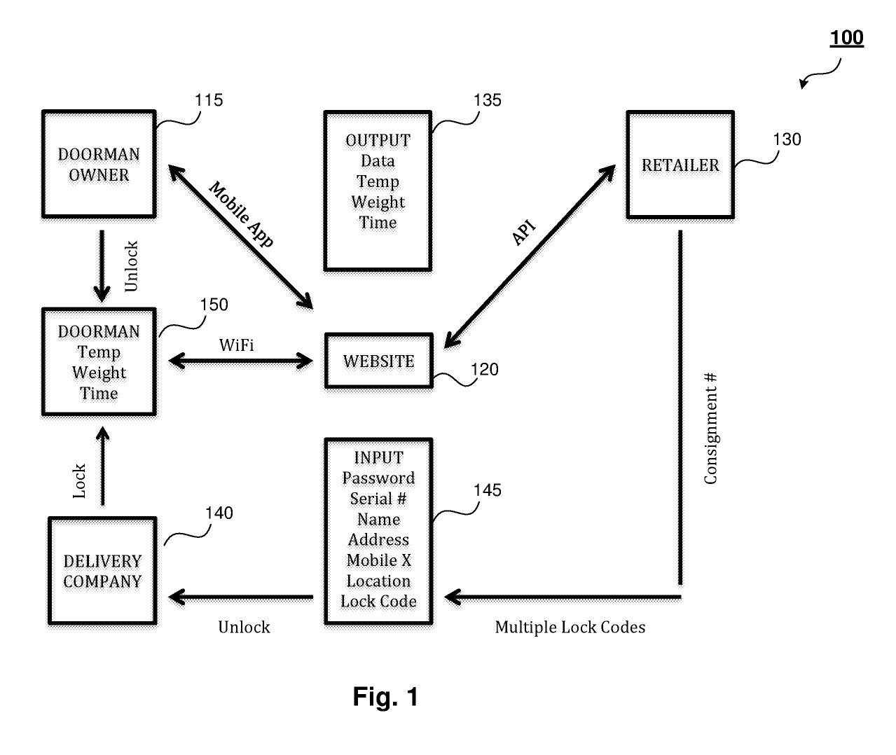

FIG. 1 is a schematic representation illustrating flow of information 100 in a secure delivery storage system of the present disclosure. In this example, the storage unit is referred to as a “Doorman”, as the storage unit performs some functions traditionally performed by a doorman or concierge. A registered user of the website 120 is an owner of a Doorman storage unit 150. The registered user uses a computing device 115 to communicate with a website 120 hosted on a server connected to a communications network. In one arrangement, the registered user uses a browser executing on a processor of the computing device 115 to communicate with the website 120. In an alternative arrangement, the registered user uses a software application (“app”) installed on the computing device 115 to communicate with the website 120.

The website 120 communicates with the Doorman storage unit 150 via the communications network. In one arrangement, the Doorman storage unit 150 has a physical connection to the communications network, such as an Ethernet connection. In an alternative arrangement, the Doorman storage unit 150 has a wireless connection to the communications network. Such a wireless connection may be implemented, for example, using a Wi-Fi connection, Bluetooth connection, 3G or 4G telephony connection, or the like.

The registered user uses the computing device 115 to browse a retail website 130. The user selects a product for purchase and delivery. During the checkout process, the user selects an icon associated with the website 120. In one arrangement, a plug-in executing within the browser being accessed by the user produces the icon. In another arrangement, the icon appears on the checkout webpage of the retail website 130 as a result of an agreement between the provider of the website 120 and the retailer 130. In such an arrangement, the icon may be implemented, for example, using JavaScript to create a link between the retail website 130 and the website 120. In one particular example, JavaScript is used to create a connection between Enterprise Resource Planning (ERP) business management software of the retailer and the website 120.

Selecting the icon causes the retailer website 130 to establish a connection to the website 120, indicating that the registered user has made a purchase and goods are to be delivered. Depending on the implementation, the user logs into the website 120 or is otherwise verified, such as by IP device verification, verification via oAuth, third-party site verification (e.g., Facebook, Twitter, or the like), or other verification means. Having logged into the website 120, the website 120 optionally auto-completes fields in the checkout page of the retail website 130, based on information stored in a user profile associated with the user on the website 120. Information in the user profile may have been provided by the user upon registering with the website 120.

The website 120 generates a delivery access code, which is presented to the retailer website 130 and to the Doorman storage unit 150. The retailer website 130 generates delivery instructions 145 for a delivery company 140. The delivery instructions 145 include the delivery access code (or password) and the name and address of the registered user. The delivery instructions 145 optionally include further information, such as the specific location of the Doorman storage unit 150 on the property, such as “on the back verandah” or “behind left side gate”. Further information may include contact details for the registered user, such as a telephone number or email address. Depending on the implementation and the goods to be delivered, the delivery information may also include a temperature at which to set a storage compartment of the Doorman storage unit 150, weight of the goods to be delivered, and dimensions of the goods to be delivered, which may be necessary to allow either the registered user or a delivery agent to configure the storage locker appropriately or control access to one or more compartments within the storage unit 150.

The delivery company 140 uses the delivery access code to unlock the Doorman storage unit 150 and place the goods in the relevant compartment. The scales associated with the compartments record the delivered weight and transmit the delivered weight to the control module of the Doorman storage unit 150. The control module communicates output data 135 to the website 120, wherein the output data may include, for example, one or more of delivery date and time, delivered weight(s), and temperature(s) of the relevant compartment at the time of delivery.

In one arrangement, the website 120 transmits a delivery alert to the user to inform the user that the delivery has been made. In another arrangement, the Doorman storage unit 150 transmits the delivery alert to the user. The delivery alert may be, for example, a Short Message Service (SMS) text message, a Multimedia Messaging Service (MMS) message, an email, or the like.

The user then uses an owner access code provided by the website 120 or selected by the user during installation of the storage unit 250 to unlock the Doorman storage unit 150 and retrieve the delivered goods. In one arrangement, the website 120 allocates an owner access code during registration of the user and the user uses the same owner access code to access the Doorman storage unit 150 across multiple deliveries.

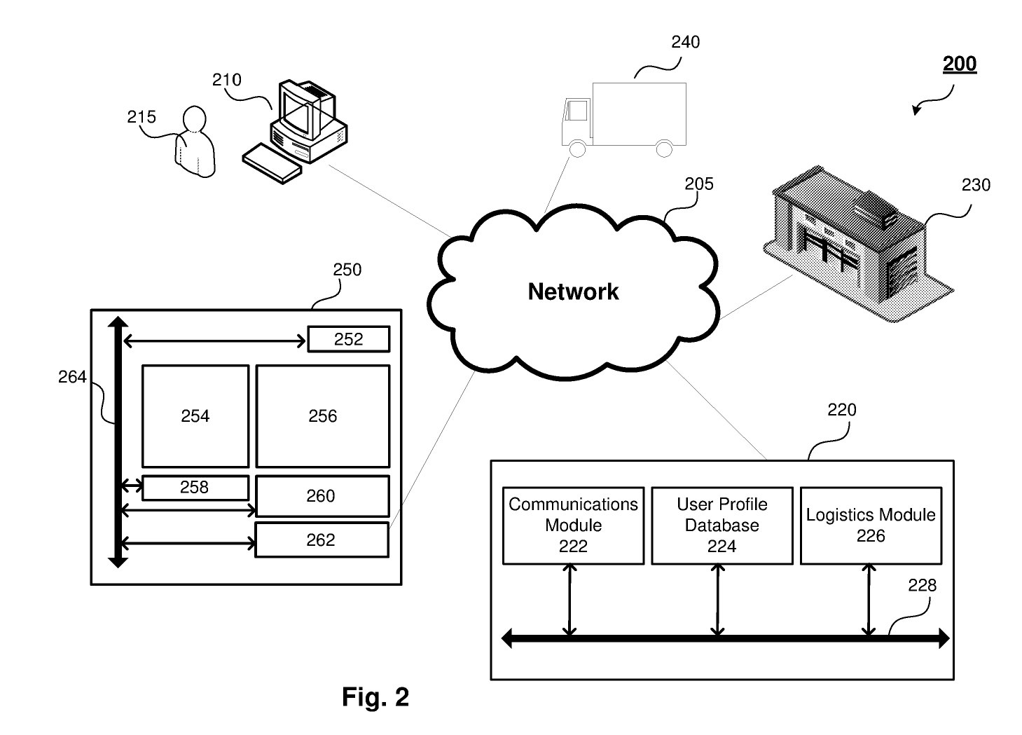

FIG. 2 is a schematic representation of a system 200 on which one or more embodiments of the present disclosure may be practised. The system 200 includes a computer server 220 for hosting a delivery system website. The server 220 includes a communications module 222 for coupling the server 220 to a communications network 205. The communications network 205 may be implemented using one or more wired or wireless transmission links and may include, for example, a cellular telephony network, a dedicated communications link, a local area network (LAN), a wide area network (WAN), the Internet, a telecommunications network, or any combination thereof. A telecommunications network may include, but is not limited to, a telephony network, such as a Public Switch Telephony Network (PSTN), a cellular (mobile) telephone cellular network, a short message service (SMS) network, or any combination thereof.

The server 220 also includes a user profile database 224 for storing user data relating to users registered with the delivery system website. Such user data may include, for example, but is not limited to, names, addresses, and contact details. Each registered user is associated with a storage unit purchased, hired, or leased in relation to the delivery system website. Accordingly, the user data for each registered user also includes a serial number of the storage unit owned by or associated with that registered user.

The server 220 further includes a logistics module 226 for generating delivery access codes that are used by delivery agencies to unlock and access the storage units when making authorised deliveries. The server 220 further include a bus 228 to which each of the communications module 222, user profile database 224 and logistics module 226 are coupled so as to exchange data. The server 220 may be implemented using a general purpose computer, or the like, and includes at least one processor and memory, which are not illustrated in FIG. 2 for the sake of clarity.

The system 200 also includes a user computing device 210 accessed by a user 215. The computing device 210 may be a general purpose computer, such as a desktop computer or laptop, a smartphone, a tablet device, or the like. The computing device 210 is coupled to the communications network 205. The user 215 uses the computing device 210 to access the delivery system website hosted by the server 220 and register with the delivery system website. The user 215 is able to purchase a storage unit for use in receiving deliveries. In one arrangement, the logistics module 226 issues the user 215 with an owner access code for use with the purchased storage unit. In another arrangement, each storage unit is associated with an owner access code that is made available to the user when the storage unit is delivered to the user. In another arrangement, the user is able to set and change the owner access code using a control panel of the storage unit.

In the example of FIG. 2, the user 215 purchases the storage unit 250, which is coupled to the communications network 205 by a storage unit communications module 262. As noted above, the storage communications module 262 may use one or more wired or wireless connections, such as an Ethernet connection, Wi-Fi connection, Bluetooth connection, or cellular telephony connection.

The storage unit 250 in the example of FIG. 2 includes a first, non-refrigerated compartment 254 with an associated first scale 258 and a second, refrigerated compartment 256 with an associated second scale 260. The first scale 258 measures the weight of any contents of the first compartment 254 and the second scale 260 measures the weight of any contents of the second compartment 256. The first and second scales 258, 260 may be implemented using load cells, mechanical scales, electronic scales, or the like. It will be appreciated that the storage unit 250 may include many compartments for receiving different types of goods or deliveries on different days. Further, the size of the compartments may vary, so as to accommodate different types of goods.

In one arrangement, the temperatures of the first and second compartments 254, 256 are controlled by thermocouples and a thermostat controller or other suitable device(s), in combination with a cooling device, such as a compression motor, for refrigerating the second compartment 256. In such an arrangement, each of the first and second compartments 254, 256 includes a thermometer for recording the temperature of the respective compartments. The thermometers record the compartment temperatures periodically and store the recorded temperatures in a log for later inspection to validate a cold chain in relation to delivered goods. The log may be recorded in a memory of the storage unit 250 or a memory of the website server 220. In one arrangement, the recorded temperatures are periodically transmitted to the website server 220 or the owner. In another arrangement, the storage unit 250 generates an alarm if the recorded temperature of a compartment 254, 256 is outside a predefined temperature range for that compartment.

The storage unit 250 also includes a control module 252 for controlling access to the first and second compartments 254, 256. In one arrangement, a single lid is provided that moves from an open configuration to a closed configuration and is secured in the closed configuration by a lock. In one arrangement, the lock is a solenoid lock. The control module 252 controls movement of the lock, based on a code received at a user interface. In one arrangement, the user interface is a keypad for receiving a delivery access code or owner access code. In another arrangement, the user interface is a touchscreen for receiving a delivery access code or owner access code.

In another arrangement, the user interface includes a voice recognition module, a retina scanning device, a fingerprint scanner, or other biometric recognition device to authorise access to the first and second compartments 254, 256. Biometric recognition devices are generally only suitable for use in validating an owner, as the biometric details of different delivery agents will generally not be known and thus the biometric recognition devices are generally used in conjunction with one of the other described user interfaces. In one embodiment, however, biometric details of a delivery agent are provided to the delivery system website for validation. In such an embodiment, the communications module 222 of the server 220 transmits the delivery agent biometric information to the storage unit 250 for use by the control unit 252 in validating a user wanting to access the storage unit 250.

The storage unit 250 further includes a second bus 264 to which each of the control unit 252, first scale 258, second scale 260, and storage unit communications module 262 are coupled, so as to communicate with each other.

The system further includes a retailer 230. The retailer 230 may be a physical store that receives orders in person from the user 215, a physical store or call centre that receives telephone orders from the user 215, or an online website coupled to the communications network 205 that receives orders from the user 215 via inputs presented to the computing device 210.

In one example, the user 215 uses a browser executing on the computing device 210 to purchase a product offered for sale on the retailer website 230. During the checkout process, the user 215 selects a displayed icon associated with the delivery system website. Clicking on the icon generates a temporary application programming interface (API) link between the retailer website 230 and the server 220. As described above with reference to the retail website 130 and the website 120 of FIG. 1, the icon may be implemented using JavaScript to create a link between the retail website 230 and the website 220, as a result of an agreement between the retailer and the website 220.

The server 220 pushes purchasing information relating to the user 215 to the retailer website 230. Such purchasing information is used to populate delivery fields on the webpage of the retailer and may include, for example, the name and address of the user 215 and delivery instructions.

Once the user 215 makes payment to the retailer website 230, the retailer website 230 establishes a temporary link with the website server 220. The retailer 230 provides delivery information that includes, for example, the total weight of the order and a Personal Identification Number (PIN). In one arrangement, the PIN is a portion of a delivery agent consignment number. In another arrangement, the total weight of the order is accompanied by a split into an ambient portion weight and a chilled portion weight, indicating the respective portions of the delivery that are to be placed into a compartment of the storage unit 250 having an ambient temperature and a compartment of the storage unit 250 that is refrigerated.

The website server 220 pushes the PIN to the storage unit 250 to function as a delivery access code for the goods to be delivered. The system 200 also shows a delivery agent 240 which delivers the purchased goods to the storage unit 250. The delivery agent 240 enters the PIN using a user interface of the control module 252. The control module 252 validates the entered PIN against the PIN received from the website server 220. If the entered PIN matches the expected PIN, the control module 252 releases the lock securing the lid and the delivery agent 240 is able to access the first and second compartments 254, 256.

In this example, the delivery agent 252 places goods to be stored at ambient temperature in the first, non-refrigerated compartment 254. The delivery agent places goods that are to be chilled in the second, refrigerated compartment 256. In one arrangement, the delivery agent closes the lid and presses a button or enters a code to lock the storage unit 250. In another arrangement, the delivery agent closes the lid and the lock automatically secures the lid after a first predefined period of time, such as 10 seconds. If the delivery agent needs to access the storage unit 250 again, one arrangement allows the PIN to be reused within a second predefined period of time of the initial use by the delivery agent. Such a second predefined period of time may be, for example, 10 minutes to allow the delivery agent to make multiple trips between the storage unit 250 and a delivery van. Each of the first and second predefined periods of time may be implemented using a timer in the control unit 252.

The first and second scales 258, 260 determine the weight of the contents in each of the respective first and second compartments 254, 256 and report the measured weights to the control unit 252. As noted above, the temperatures of the first and second compartments 254, 256 are optionally monitored using thermometers. In such an arrangement, the thermometers report the temperatures of the compartments 254, 256 at the time of delivery to the control unit 252. The control unit 252 sends delivery data including the measured weights and delivery time via the storage unit communications module 262 to the website server 220. The delivery data may also include, for example, the temperatures of the compartments 254, 256 at the time of delivery. The website server 220 stores the delivery data. The ability of the storage unit 250 to transmit delivery data such as the weight and temperature of the delivered goods provides a system that can verify proof of delivery and cold chain in relation to the delivered goods. In one implementation, the website server 220 sends a delivery alert to the user 215. In another implementation, the storage unit communications module 262 sends a delivery alert to the user 215. The user 215 then uses the owner access code to unlock the lid of the storage unit 250 and access the delivered goods.

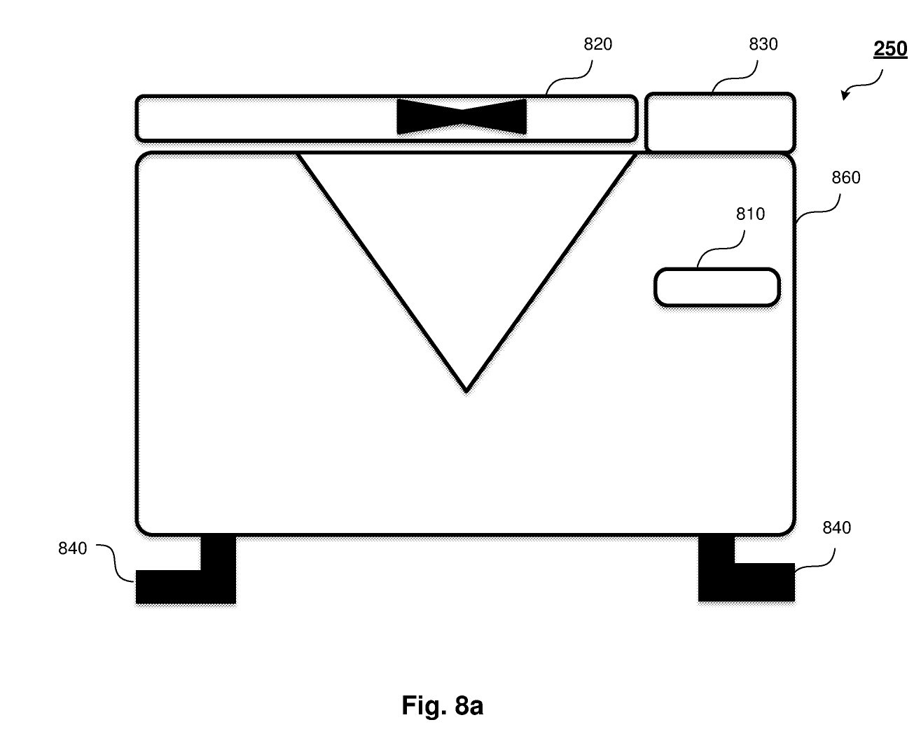

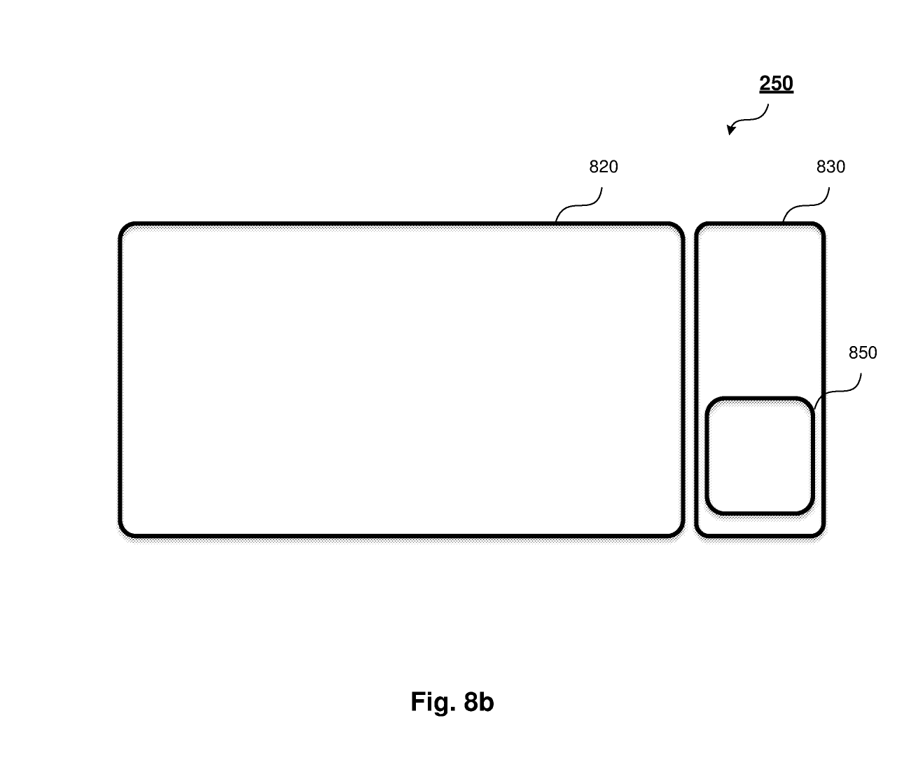

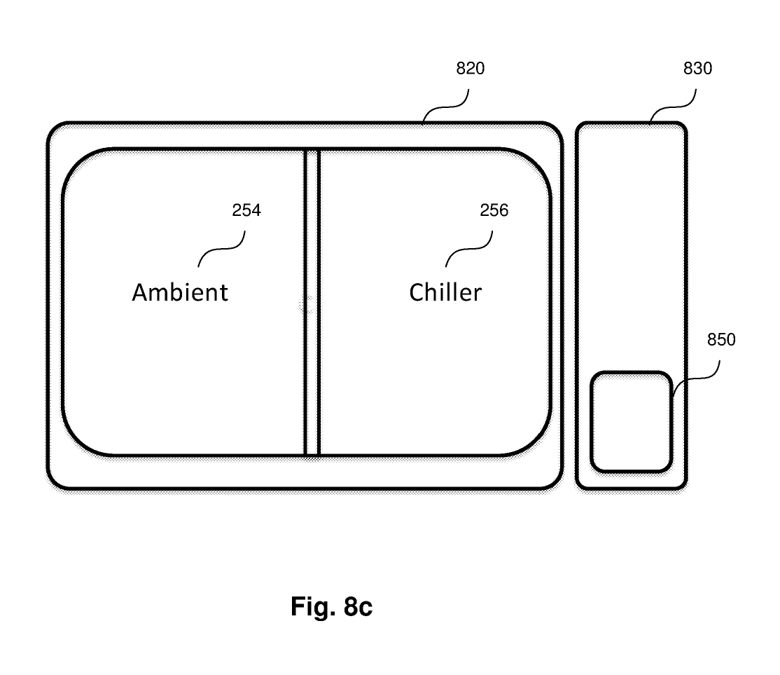

FIGS. 8a and 8b are schematic representations of an embodiment of the secure storage unit 250 of FIG. 2. FIG. 8a is a front view of the storage unit 250 having a main body portion 860, a lid 820 and supporting legs 840. The storage unit 250 also includes a lid 820 and a top cap 830. In this example, the top cap 830 is fixed and contains the communications module 222. The top cap 830 optionally includes electronics for controlling actuation of a lock to secure the lid 820. In one arrangement, the lid 820 pivots on an edge to allow access to one or more compartments within the body portion 860. The top cap 830 optionally includes a receptacle for receiving letters, delivery documentation, and small parcels. In an alternative embodiment, the body portion 860 includes such a receptacle. In one arrangement, access to the receptacle is via an opening located on an internal wall of the body portion, such as may be accessible by opening the lid 820. In one implementation, a sliding or pivoting door is used to close the receptacle. The storage unit 250 also includes a user interface 810 for receiving access codes from delivery agents and owners. In one arrangement, a lower portion of the body portion 860 houses a compressor for regulating temperature in one or more refrigerated or chilled compartments of the storage unit 250.

FIG. 8b is a top view of the storage unit 250 of FIG. 8a. The top cap 830 includes a module 850. In one arrangement, the module 850 houses the communications module 222. The module 850 also optionally houses a control device for controlling actuation of a lock to secure the lid 820.

FIG. 8c is a top view of a further embodiment of the storage unit 250 of FIG. 8a, showing a first, non-refrigerated (i.e., ambient temperature) compartment 254 and a second, refrigerated (i.e., chilled) compartment 256, as described above with reference to FIG. 2. Thus, delivered goods may be placed into the relevant compartment 254, 256. In one implementation, a single door or hatch covers access to both compartments 254, 256. The single door or hatch may be the lid 820 or may be a separate door or hatch underneath the lid 820.

In another implementation, each compartment 254, 256 has its own respective door or hatch beneath the lid 820. Such an implementation may be coupled to one or more locking devices to provide and control independent access to the respective compartments 254, 256. It will be appreciated that different implementations may utilise any number of ambient and refrigerated compartments, with one or more doors or hatches providing access to different combinations of such compartments.

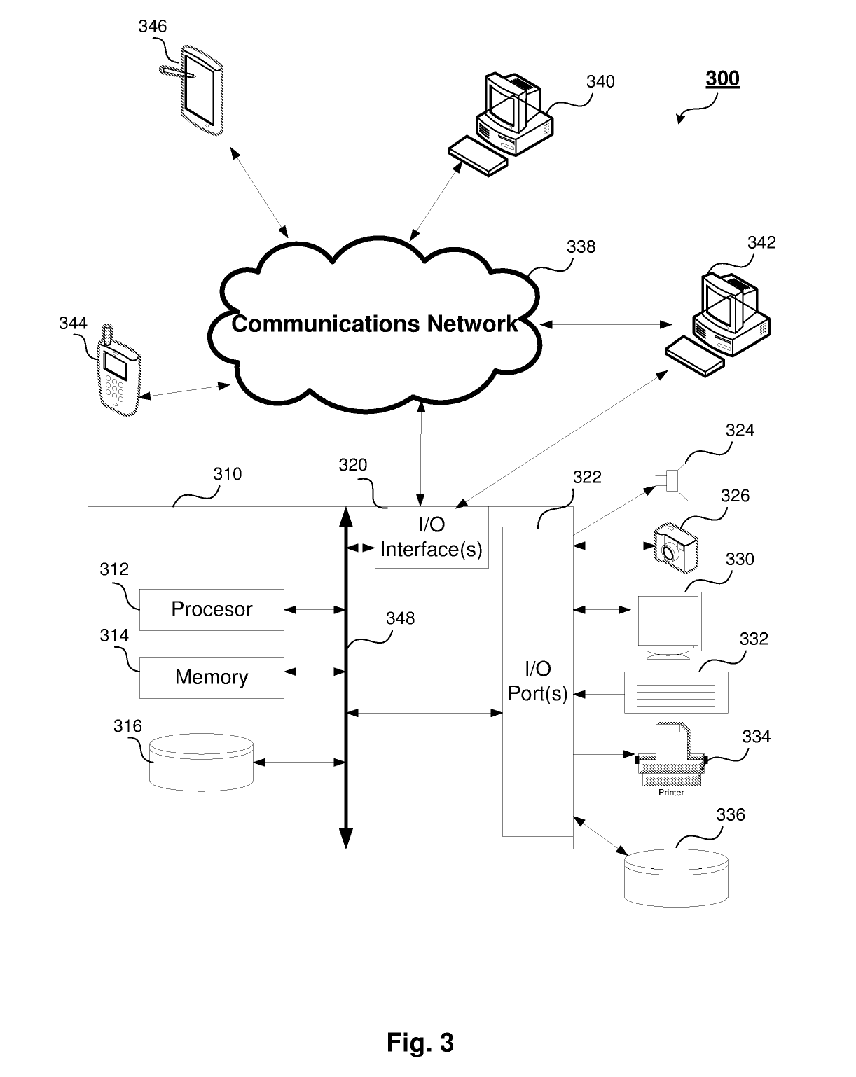

The secure delivery method and system of the present disclosure may be practised using a computing device, such as a general purpose computer or computer server. For example, a general purpose computer or server may be used to implement the computing device 210 and the server 220 of FIG. 2. FIG. 3 is a schematic block diagram of a system 300 that includes a general purpose computer 310. The general purpose computer 310 includes a plurality of components, including: a processor 312, a memory 314, a storage medium 316, input/output (I/O) interfaces 320, and input/output (I/O) ports 322. Components of the general purpose computer 310 generally communicate using one or more buses 348.

The memory 314 may be implemented using Random Access Memory (RAM), Read Only Memory (ROM), or a combination thereof. The storage medium 316 may be implemented as one or more of a hard disk drive, a solid state “flash” drive, an optical disk drive, or other storage means. The storage medium 316 may be utilised to store one or more computer programs, including an operating system, software applications, and data. In one mode of operation, instructions from one or more computer programs stored in the storage medium 316 are loaded into the memory 314 via the bus 348. Instructions loaded into the memory 314 are then made available via the bus 348 or other means for execution by the processor 312 to implement a mode of operation in accordance with the executed instructions.

One or more peripheral devices may be coupled to the general purpose computer 310 via the I/O ports 322. In the example of FIG. 3, the general purpose computer 310 is coupled to each of a speaker 324, a camera 326, a display device 330, an input device 332, a printer 334, and an external storage medium 336. The speaker 324 may be implemented using one or more speakers, such as in a stereo or surround sound system.

The camera 326 may be a webcam, or other still or video digital camera, and may download and upload information to and from the general purpose computer 310 via the I/O ports 322, dependent upon the particular implementation. For example, images recorded by the camera 326 may be uploaded to the storage medium 316 of the general purpose computer 310. Similarly, images stored on the storage medium 316 may be downloaded to a memory or storage medium of the camera 326. The camera 326 may include a lens system, a sensor unit, and a recording medium.

The display device 330 may be a computer monitor, such as a cathode ray tube screen, plasma screen, or liquid crystal display (LCD) screen. The display 330 may receive information from the computer 310 in a conventional manner, wherein the information is presented on the display device 330 for viewing by a user. The display device 330 may optionally be implemented using a touch screen to enable a user to provide input to the general purpose computer 310. The touch screen may be, for example, a capacitive touch screen, a resistive touchscreen, a surface acoustic wave touchscreen, or the like.

The input device 332 may be a keyboard, a mouse, a stylus, drawing tablet, or any combination thereof, for receiving input from a user. The external storage medium 336 may include an external hard disk drive (HDD), an optical drive, a floppy disk drive, a flash drive, or any combination thereof and may be implemented as a single instance or multiple instances of any one or more of those devices. For example, the external storage medium 336 may be implemented as an array of hard disk drives.

The I/O interfaces 320 facilitate the exchange of information between the general purpose computing device 310 and other computing devices. The I/O interfaces may be implemented using an internal or external modem, an Ethernet connection, or the like, to enable coupling to a transmission medium. In the example of FIG. 3, the I/O interfaces 322 are coupled to a communications network 338 and directly to a computing device 342. The computing device 342 is shown as a personal computer, but may be equally be practised using a smartphone, laptop, or a tablet device. Direct communication between the general purpose computer 310 and the computing device 342 may be implemented using a wireless or wired transmission link.

The communications network 338 may be implemented using one or more wired or wireless transmission links and may include, for example, a dedicated communications link, a local area network (LAN), a wide area network (WAN), the Internet, a telecommunications network, or any combination thereof. A telecommunications network may include, but is not limited to, a telephony network, such as a Public Switch Telephony Network (PSTN), a mobile telephone cellular network, a short message service (SMS) network, or any combination thereof. The general purpose computer 310 is able to communicate via the communications network 338 to other computing devices connected to the communications network 338, such as the mobile telephone handset 344, the touchscreen smartphone 346, the personal computer 340, and the computing device 342.

One or more instances of the general purpose computer 310 may be utilised to implement a server acting as a host for a website to implement a secure delivery method in accordance with the present disclosure. In such an embodiment, the memory 314 and storage 316 are utilised to store data relating to registered users and access codes. Software for implementing the delivery system is stored in one or both of the memory 314 and storage 316 for execution on the processor 312. The software includes computer program code for implementing method steps of registered users, generating access codes, transmitting access codes, receiving output data and transmitting delivery alerts in accordance with the secure delivery method described herein.

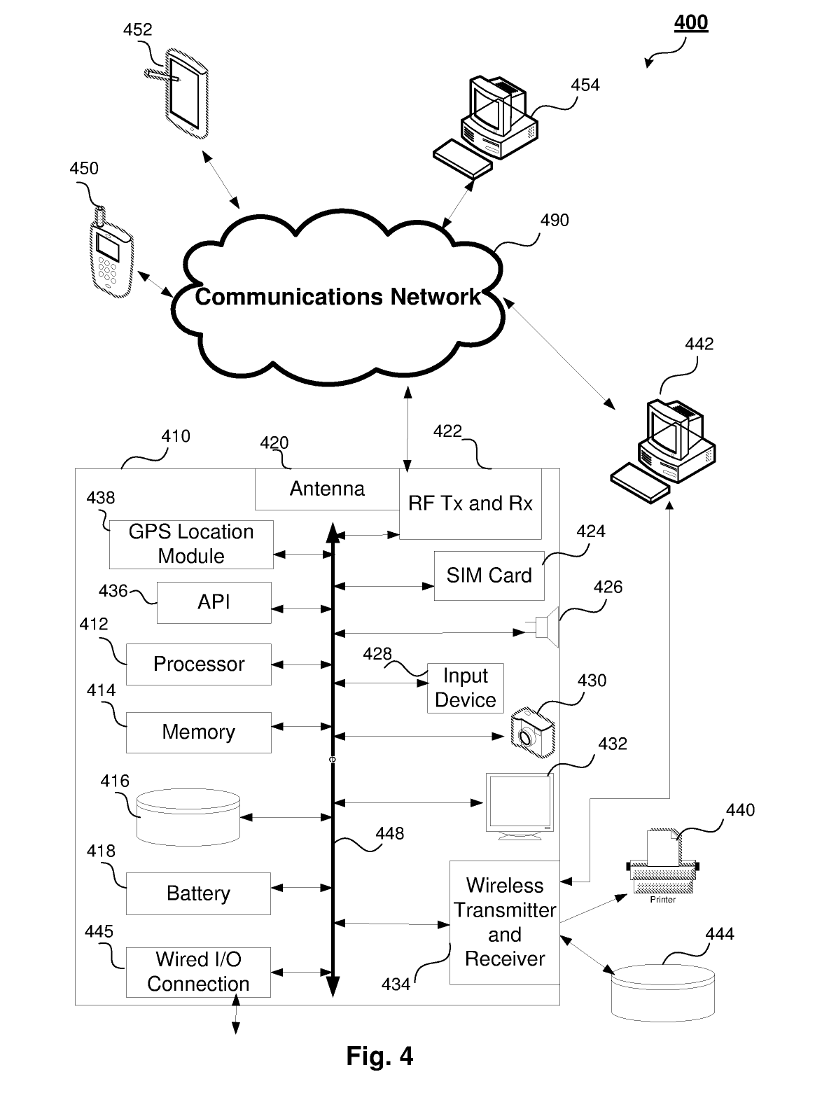

FIG. 4 is a schematic block diagram of a system 400 on which one or more aspects of a secure delivery method and system of the present disclosure may be practised. The system 400 includes a portable computing device in the form of a smartphone 410, which may be used as the computing device 210 accessed by a registered user of the delivery system in FIG. 2. The smartphone 410 includes a plurality of components, including: a processor 412, a memory 414, a storage medium 416, a battery 418, an antenna 420, a radio frequency (RF) transmitter and receiver 422, a subscriber identity module (SIM) card 424, a speaker 426, an input device 428, a camera 430, a display 432, and a wireless transmitter and receiver 434. Components of the smartphone 410 generally communicate using one or more bus connections 448 or other connections therebetween. The smartphone 410 also includes a wired connection 445 for coupling to a power outlet to recharge the battery 418 or for connection to a computing device, such as the general purpose computer 310 of FIG. 3. The wired connection 445 may include one or more connectors and may be adapted to enable uploading and downloading of content from and to the memory 414 and SIM card 424.

The smartphone 410 may include many other functional components, such as an audio digital-to-analogue and analogue-to-digital converter and an amplifier, but those components are omitted for the purpose of clarity. However, such components would be readily known and understood by a person skilled in the relevant art.

The memory 414 may include Random Access Memory (RAM), Read Only Memory (ROM), or a combination thereof. The storage medium 416 may be implemented as one or more of a solid state “flash” drive, a removable storage medium, such as a Secure Digital (SD) or microSD card, or other storage means. The storage medium 416 may be utilised to store one or more computer programs, including an operating system, software applications, and data. In one mode of operation, instructions from one or more computer programs stored in the storage medium 416 are loaded into the memory 414 via the bus 448. Instructions loaded into the memory 414 are then made available via the bus 448 or other means for execution by the processor 412 to implement a mode of operation in accordance with the executed instructions.

The smartphone 410 also includes an application programming interface (API) module 436, which enables programmers to write software applications to execute on the processor 412. Such applications include a plurality of instructions that may be pre-installed in the memory 414 or downloaded to the memory 414 from an external source, via the RF transmitter and receiver 422 operating in association with the antenna 420 or via the wired connection 445.

The smartphone 410 further includes a Global Positioning System (GPS) location module 438. The GPS location module 438 is used to determine a geographical position of the smartphone 410, based on GPS satellites, cellular telephone tower triangulation, or a combination thereof. The determined geographical position may then be made available to one or more programs or applications running on the processor 412.

The wireless transmitter and receiver 434 may be utilised to communicate wirelessly with external peripheral devices via Bluetooth, infrared, or other wireless protocol. In the example of FIG. 4, the smartphone 410 is coupled to each of a printer 440, an external storage medium 444, and a computing device 442. The computing device 442 may be implemented, for example, using the general purpose computer 310 of FIG. 3.

The camera 426 may include one or more still or video digital cameras adapted to capture and record to the memory 414 or the SIM card 424 still images or video images, or a combination thereof. The camera 426 may include a lens system, a sensor unit, and a recording medium. A user of the smartphone 410 may upload the recorded images to another computer device or peripheral device using the wireless transmitter and receiver 434, the RF transmitter and receiver 422, or the wired connection 445.

In one example, the display device 432 is implemented using a liquid crystal display (LCD) screen. The display 432 is used to display content to a user of the smartphone 410. The display 432 may optionally be implemented using a touch screen, such as a capacitive touch screen or resistive touchscreen, to enable a user to provide input to the smartphone 410.

The input device 428 may be a keyboard, a stylus, or microphone, for example, for receiving input from a user. In the case in which the input device 428 is a keyboard, the keyboard may be implemented as an arrangement of physical keys located on the smartphone 410. Alternatively, the keyboard may be a virtual keyboard displayed on the display device 432.

The SIM card 424 is utilised to store an International Mobile Subscriber Identity (IMSI) and a related key used to identify and authenticate the user on a cellular network to which the user has subscribed. The SIM card 424 is generally a removable card that can be used interchangeably on different smartphone or cellular telephone devices. The SIM card 424 can be used to store contacts associated with the user, including names and telephone numbers. The SIM card 424 can also provide storage for pictures and videos. Alternatively, contacts can be stored on the memory 414.

The RF transmitter and receiver 422, in association with the antenna 420, enable the exchange of information between the smartphone 410 and other computing devices via a communications network 490. In the example of FIG. 4, RF transmitter and receiver 422 enable the smartphone 410 to communicate via the communications network 490 with a cellular telephone handset 450, a smartphone or tablet device 452, a computing device 454 and the computing device 442. The computing devices 454 and 442 are shown as personal computers, but each may be equally be practised using a smartphone, laptop, or a tablet device.

The communications network 490 may be implemented using one or more wired or wireless transmission links and may include, for example, a cellular telephony network, a dedicated communications link, a local area network (LAN), a wide area network (WAN), the Internet, a telecommunications network, or any combination thereof. A telecommunications network may include, but is not limited to, a telephony network, such as a Public Switch Telephony Network (PSTN), a cellular (mobile) telephone cellular network, a short message service (SMS) network, or any combination thereof.

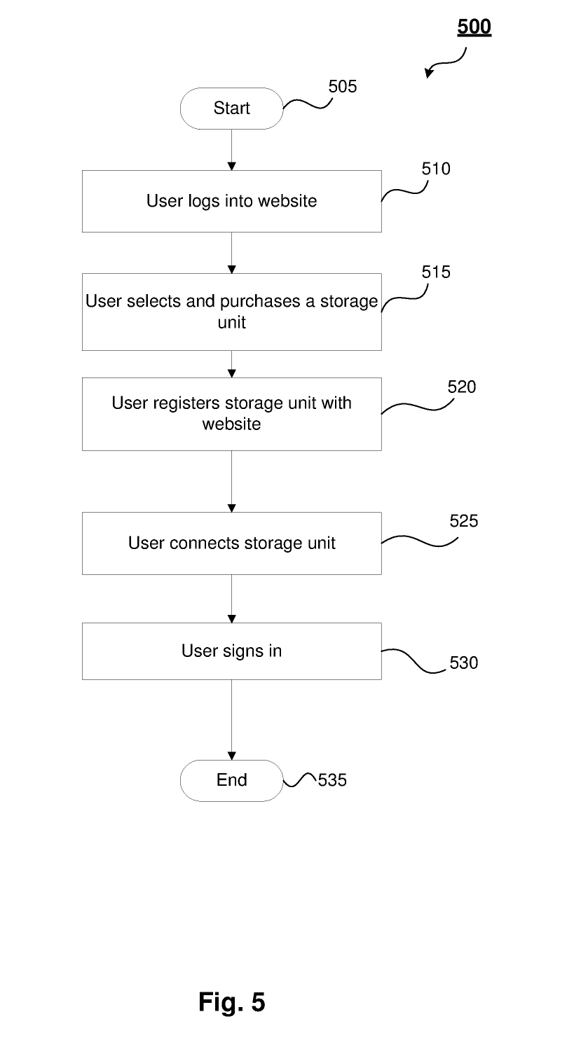

FIG. 5 is a flow diagram illustrating a method 500 of purchasing and registering a storage unit. The method 500 begins at a Start step 505 and proceeds to step 510, in which the user uses a computing device 210 to access a website hosted on a server 220. In step 515, the user selects and purchases a storage unit to be used for receiving delivered goods in a secure manner.

Control passes from step 515 to step 520, in which the user registers the storage unit with the website server 220. The website server 220 stores user information relating to the user, including the serial number of the purchased storage unit, as a user profile. Other user information may include, for example, multiple user names and contact details, and multiple owner access codes (PINs) that can be either user generated or generated by the logistics module 226 of the website server 220.

Table 1 illustrates a sample user profile associated with a user John Smith.

TABLE 1

| Field Name | Value |
|---|---|
| Serial Number | 10348790 |
| Login | username@gmail.com |
| Password | Candy745 (Facebook/Gmail login) |
| Security Question | Name of first pet |
| Name | John Smith |
| Mobile Number | 555 264 868 |
| Name | Susan Smith |
| Mobile Number | 555 266 985 |
| Address | 1 First Avenue, Serenity Hill |
| Doorman Location | Front porch near the door |
| Doorman Code 1 | 3749 |
| Doorman Code 2 | #### (issued via retailer website consignment #) |
| Doorman Code 3 | #### (issued via retailer website consignment #) |

Returning to FIG. 5, control passes to step 525, in which the user connects the purchased storage unit to a power source, such as a mains power supply or a battery. The user then signs in to the website server 220 and the registering method 500 terminates in an End step 535.

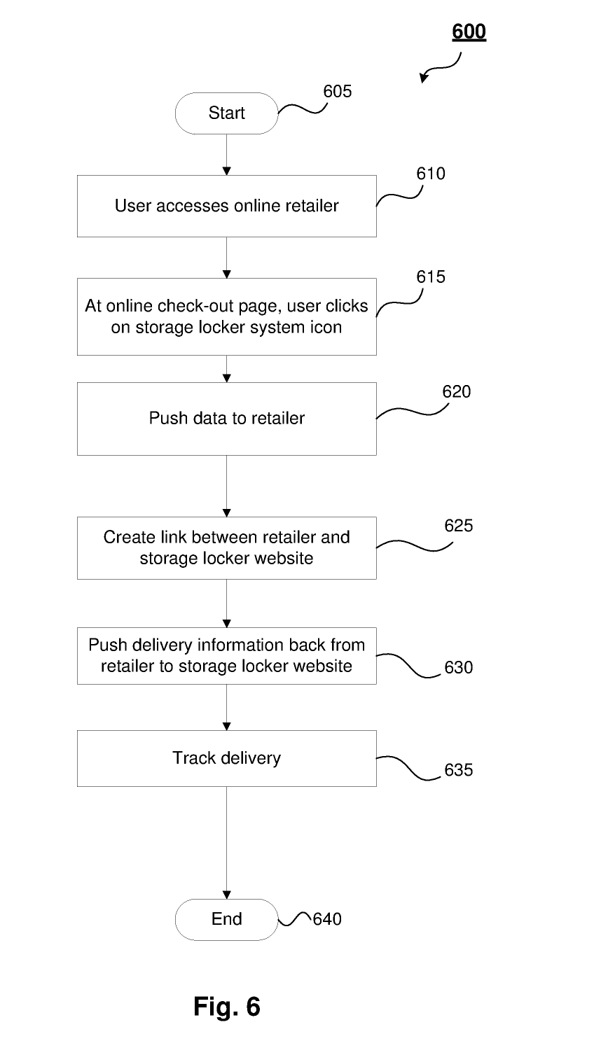

FIG. 6 is a flow diagram illustrating a method 600 of purchasing an item in conjunction with a secure delivery storage system. The method 600 begins at a Start step 605 and proceeds to step 610, in which the user uses a computing device 210 to access a website 230 of the online retailer. In step 615, the user selects an item to purchase and clicks on a storage locker system icon during the checkout process.

Control passes from step 615 to step 620, which pushes data relating to the user to the retailer 230 to assist in completing personal details and delivery information. Step 625 creates a temporary API link between the retailer website 230 and the storage locker delivery website 220. Control then passes to step 630, which pushes delivery information back from the retailer to the storage locker delivery website. Such delivery information may include, as described above, the weight of the order, including a split between items to be stored at ambient temperature and items to be stored at a chilled temperature. In step 635, tracking information is made available to the user, such as through the storage locker delivery website 220 or being pushed to an app executing on the computing device 210. Depending on the implementation, the user is able to track and trace delivery of the purchased item(s) and alter delivery arrangements, such as the delivery date and/or time.

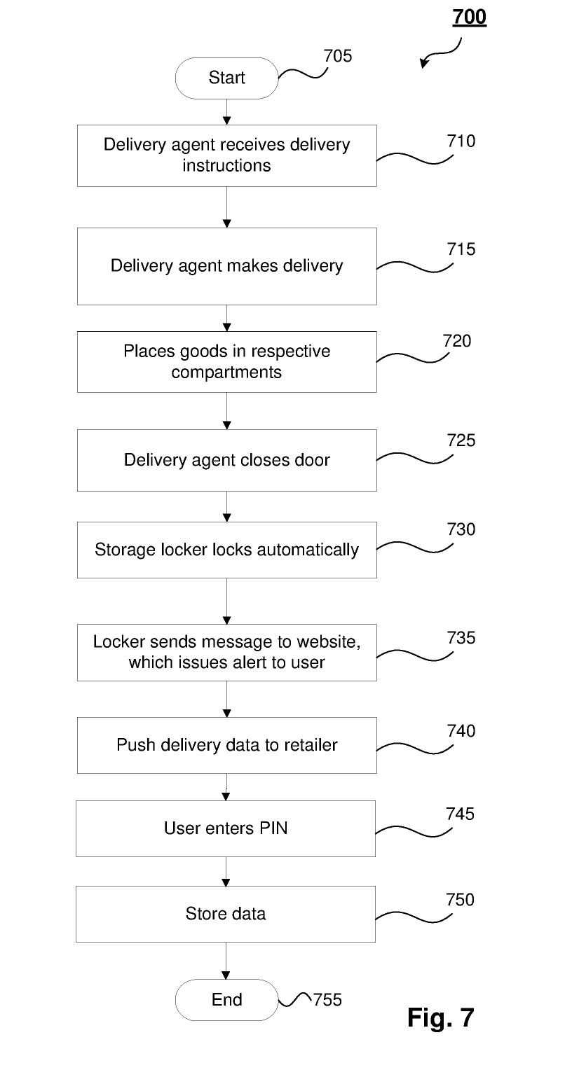

FIG. 7 is a flow diagram illustrating a method 700 of delivering a purchased item to a secure storage unit. The method 700 begins at a Start step 705 and proceeds to step 710, in which a delivery agent 240 receives delivery instructions relating to an order. Such delivery instructions may include, for example, delivery location, location of the storage unit 250, and goods to be delivered. In one arrangement, the delivery instructions also include a delivery access code to unlock the storage unit 250. In one implementation, the delivery access code is a PIN derived from a consignment order number associated with the item to be delivered.

In a following step 715, the delivery agent 240 makes delivery of the item at the physical address at which the storage unit 250 is located. In one arrangement, the delivery agent 240 first moves a protective guard from the user interface 810 of the storage unit 250. In one arrangement the lid 820 of the storage unit 250 is not locked until a delivery has been made. This allows any business to make a delivery to the storage unit 250, without having to receive an access code. In this arrangement, the delivery agent 240 slides the protective guard and the user interface 810 displays instructions to the delivery agent 240 for completing the delivery. Such instructions may instruct the delivery agent to place goods into a specific compartment of the storage unit 250.

In an alternative arrangement, the storage unit 250 is locked to prevent tampering or unauthorised access. In such an arrangement, delivery instructions provided to the delivery agent 240 include a delivery access code to gain access to one or more internal compartments of the storage unit 250. The delivery agent 240 then inputs the provided delivery access code at the user interface 810 of the storage unit 250.

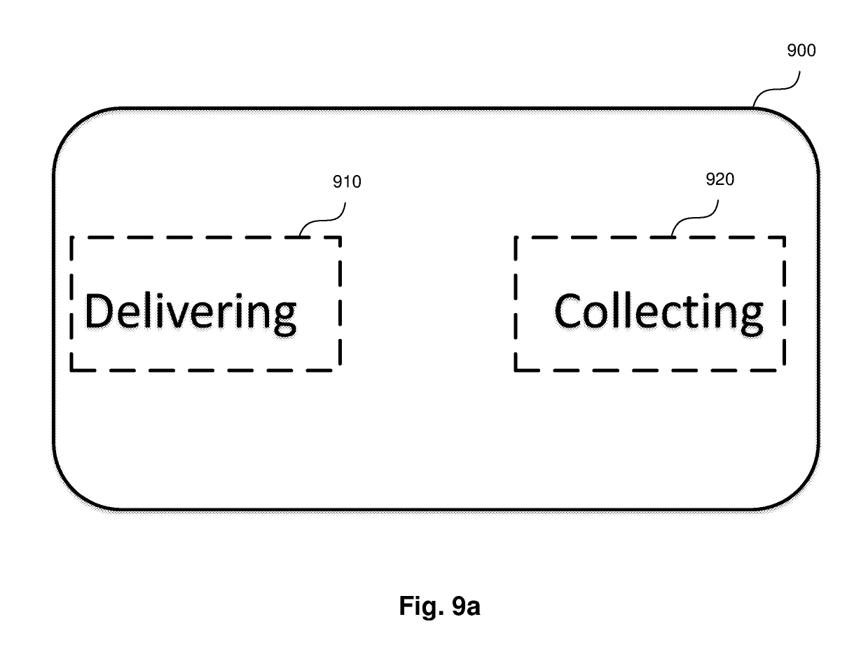

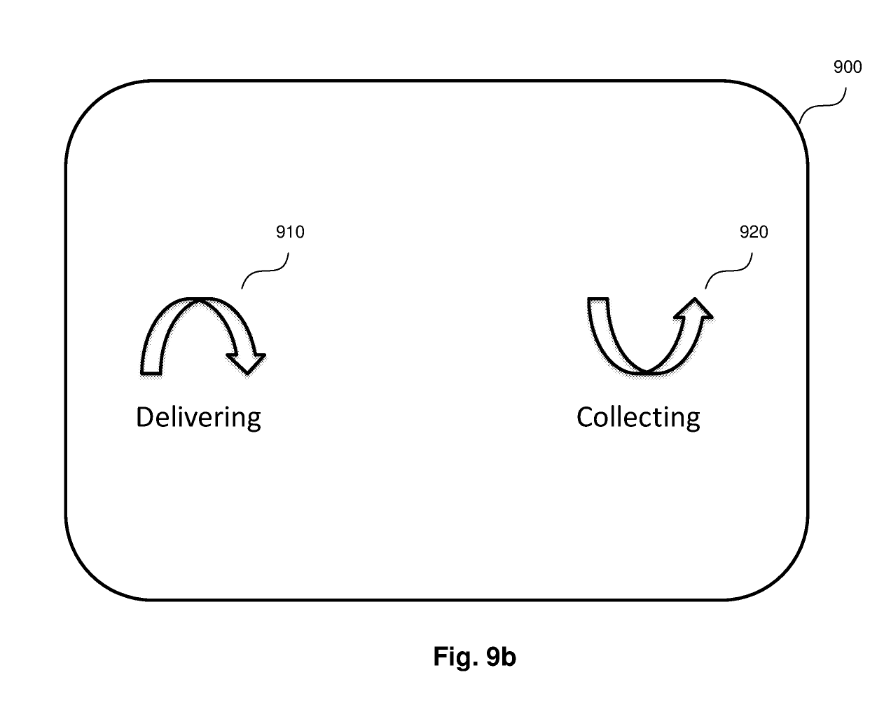

FIG. 9a is a screenshot of a welcome screen 900 of the user interface 810. The welcome screen 900 displays a delivering button 910 and a collecting button 920. FIG. 9b is an alternative representation of the welcome screen of FIG. 9a.

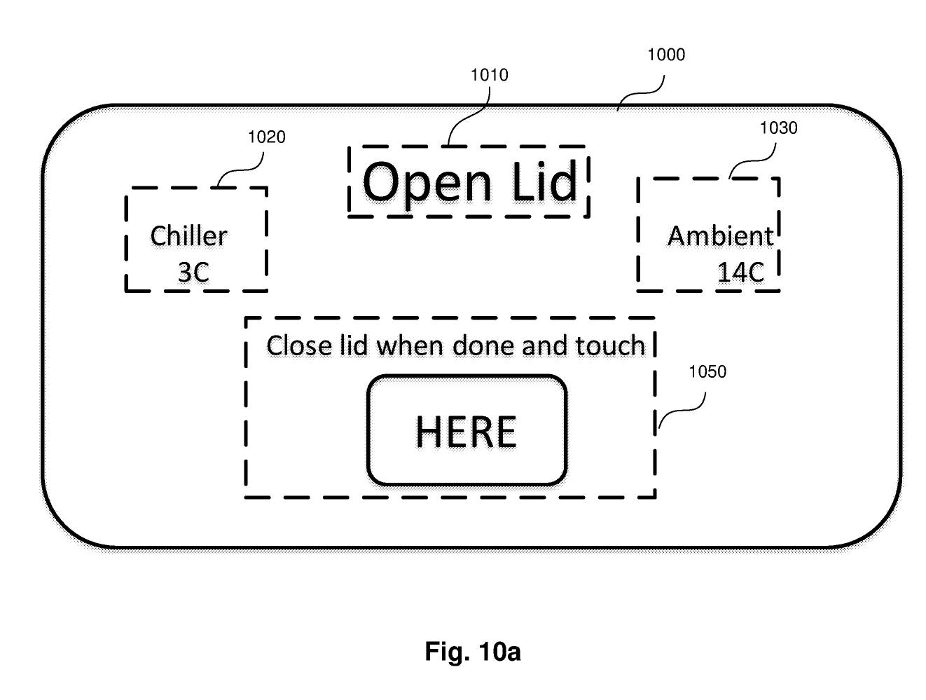

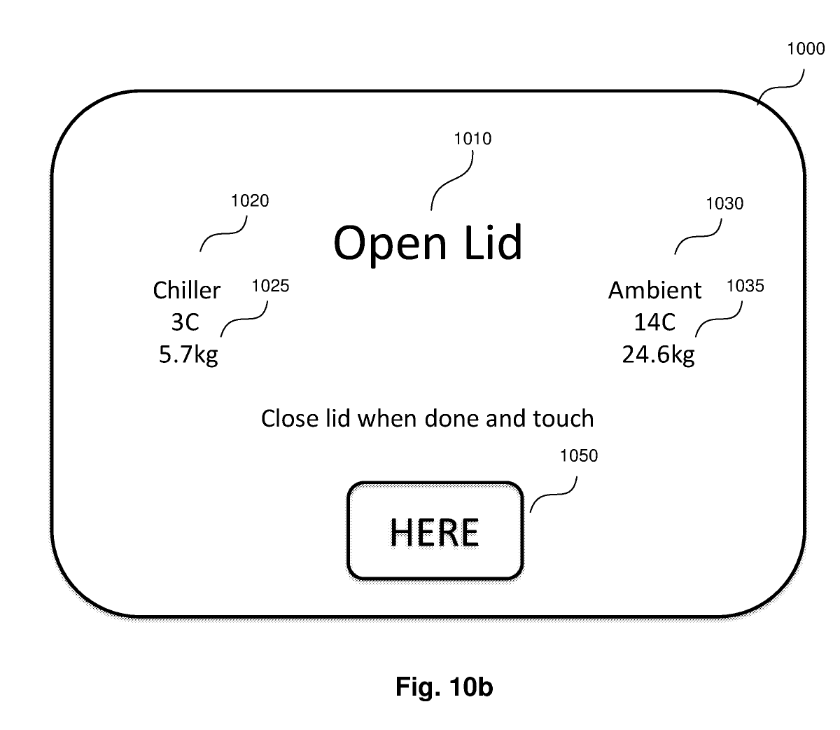

The delivery agent 240 selects the delivering button 910 and is presented with a delivery screen 1000, shown in FIG. 10a. The delivery screen 1000 has a first delivery instruction 1010 to open the lid. The delivery screen 1000 also shows the operating temperatures of the first, non-refrigerated compartment 254 as ambient temperature 1030 and the second, refrigerated compartment 256 as chiller temperature 1020. The delivery screen 1000 further includes a second delivery instruction 1050 to close the lid when done and touch a provided button. FIG. 10b is an alternative representation of the delivery screen of FIG. 10a. In the alternative representation of FIG. 10b, the delivery screen 1000 also includes: (i) a chiller weight 1025, indicating the weight of goods delivered to the second, refrigerated compartment 256; and (ii) an ambient weight 1035, indicating the weight of goods delivered to the first, non-refrigerated compartment 254.

Returning to step 715 of FIG. 7, the control module 252 validates the delivery access code and releases the lock securing the lid 820 of the storage unit 250. In step 720, the delivery agent 240 places the item(s) in the respective compartments 254, 256 of the storage unit 250 and then closes the lid in step 725.

In this arrangement, the control unit activates the lock automatically to secure the lid. In one implementation, the control unit waits a predefined period of time before activating the lock to secure the lid in the closed position. In one implementation, the predefined period of time is 120 seconds. Control passes to step 735, in which the control unit 252 uses the storage unit communications module 262 to transmit delivery data to the delivery system website 220. The delivery data may include, for example, the weight of the delivered item(s), the temperature of the delivered item(s), and the date and time the delivery was made. The delivery data may also include the weight and temperature of goods delivered to each compartment 254, 256. The website 220 in turn sends a delivery alert message to the user to notify the user that delivery of the item has been made and the item is available for collection from the storage unit 250. In one arrangement, the alert message includes a link to an app executing on the computing device 210 accessed by the user, wherein the app includes further delivery data relating to the delivered item.

In step 740, the delivery system website 220 pushes the delivery data to the retailer website 230 to confirm the details of the delivered item. Such pushed delivery data may include the weight and temperature of the first and second compartments 254, 256. This enables the retailer to confirm that required goods have been delivered, based on the weight, and that the delivered goods have been stored in accordance with required storage conditions, based on the temperature, thus avoiding the spoiling of perishable goods. The retailer website 230 then severs the temporary API link between the retailer website 230 and the website server 220. In step 745, the user accesses the storage unit 250 and is presented with the welcome screen 900 of FIG. 9. The user selects the collecting button 920 and then enters an owner access code to the user input 810 of the storage unit 250, so as to release the lock and open the lid to access the compartments 254, 256.

The method 700 of FIG. 7 is described above with reference to an instance of the storage unit 250 having a single lid 820, as depicted in FIGS. 8a and 8b. Multiple deliveries may be made to the storage unit 250 by different delivery agents entering different delivery access codes. In one arrangement, each delivery access code is configured for a single use, so that a delivery agent can only access the storage unit 250 once. Once the control module 252 receives the delivery access code, the control module 252 removes that delivery access code from a list of authorised access codes and that delivery access code will no longer be validated to allow access to the storage unit 250. After each delivery has been made, the pushed delivery data informs the retailer of the net weight of the respective delivery.

For example, a first delivery agent makes a first delivery from Retailer A that includes 10 kg to the first, non-refrigerated compartment 254 and 20 kg to the second, refrigerated compartment 256. The control unit 252 sends first delivery data to Retailer A that includes the measured weights of the first and second compartments 254, 256, as recorded by the first and second scales 258, 260. The first delivery data may also include the temperatures of the first and second compartments 254, 256, as measured by first and second thermometers in the first and second compartments 254, 256, respectively.

A second delivery agent makes a second delivery from Retailer B that includes 20 kg to the first, non-refrigerated compartment 254 and 30 kg to the second, refrigerated compartment 256. The control unit 252 sends second delivery data to Retailer B that includes the net weights of the deliveries made to the first and second compartments 254, 256, as recorded by the first and second scales 258, 260. The second delivery data may also include the temperatures of the first and second compartments 254, 256, as measured by first and second thermometers in the first and second compartments 254, 256, respectively. The storage unit communications module 262 or the website server 220 sends a delivery alert to the owner, wherein the delivery alert may include the net weight of each compartment after each delivery, the gross weight of each compartment after each delivery, or both.

In one arrangement, the storage unit 250 has multiple compartments enclosed by the top lid 820. In an alternative arrangement, the storage unit 250 has the top lid 820 and each internal compartment has a corresponding internal lid. In one implementation, the internal lids are not secured by internal locks. In an alternative implementation, each internal lid is secured by an internal lock controlled by the control module 252.

In one arrangement, a delivery access code is configured to operate the control module to release one or more locks controlling access to the lid 820 and one or more internal lids. Such a configuration ensures that a particular delivery is made to a predetermined set of one or more internal compartments of the storage unit 250. Such an arrangement can be useful in ensuring a cold chain. For example, a delivery agent is assigned a delivery code that, when entered into the user interface 810 of the storage unit 250, is passed to the control module 252 that releases an internal lock relating to an internal refrigerated compartment. Depending on the implementation, the control module 252 also releases any lock securing the lid 820. The delivery agent is thus only able to deliver the goods to the predetermined refrigerated compartment, which may be cooled to a predetermined temperature or temperature range.

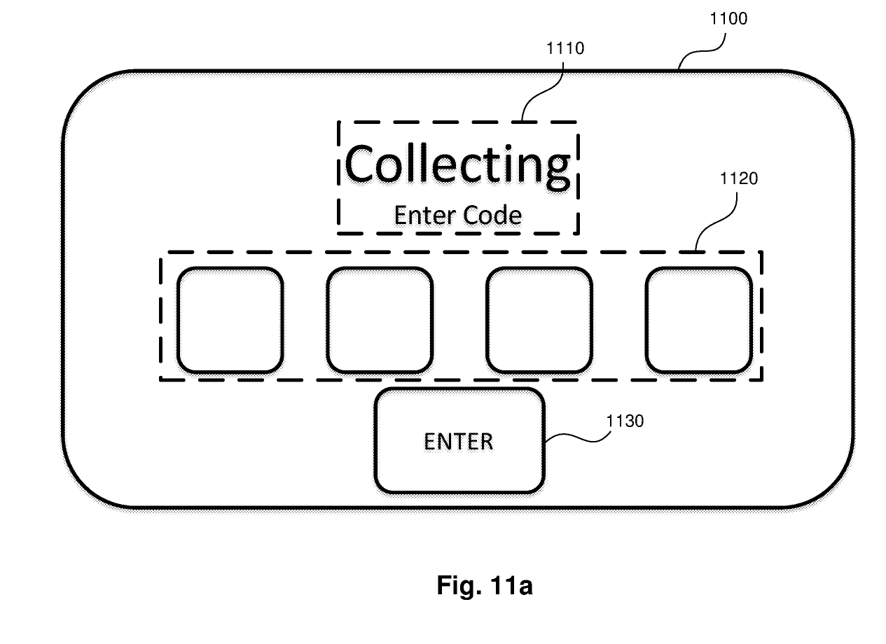

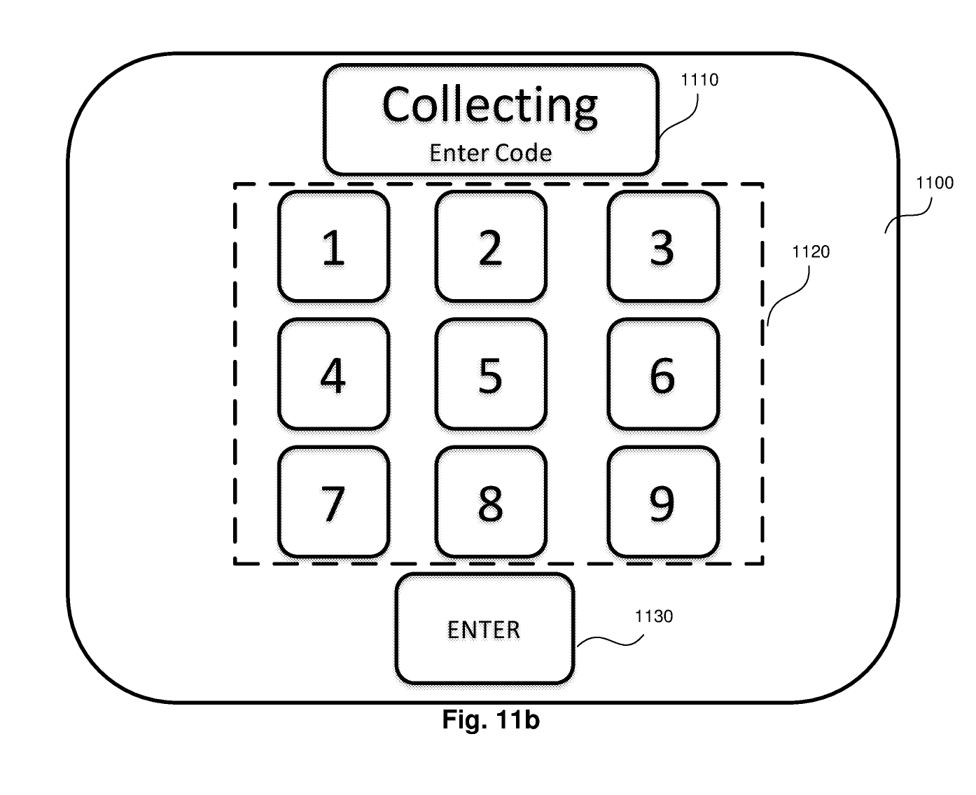

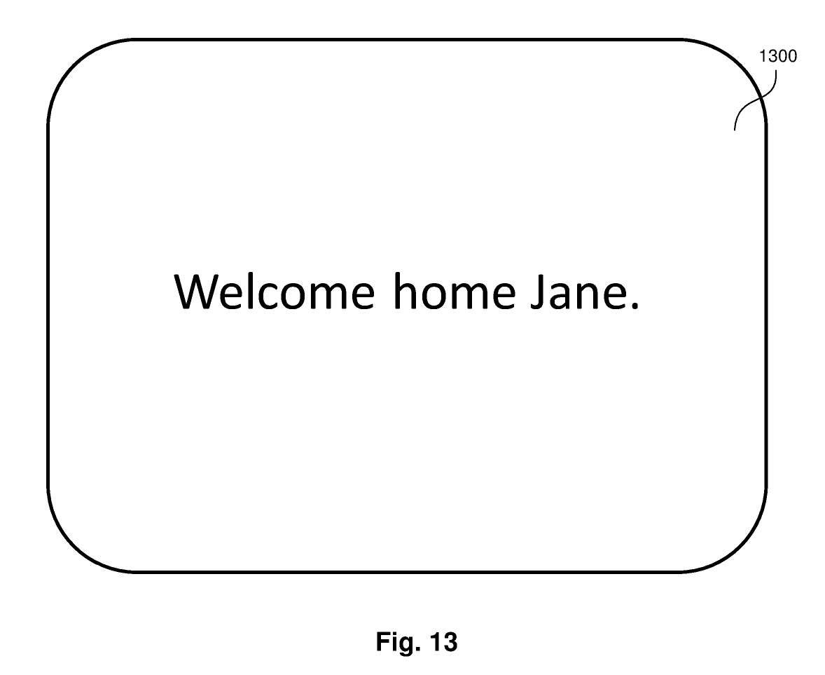

FIG. 11a is a collection screen 1100 displayed on a display device of a computing device 210 accessed by the user. The collection screen 1100 includes a first collection instruction 1110 to enter a code. The collection screen 1100 also provides a set of input fields 1120 for receiving a code. In the example of FIG. 11a, the set of input fields 1120 includes four boxes for receiving a four digit PIN. The collection screen 1100 further includes an Enter button 1130 for the user to press once the owner access code (PIN) has been entered into the set of input fields 1120. FIG. 11b is an alternative representation of the collection screen of FIG. 11a, in which the set of input fields 1120 is implemented using a numeric keypad. FIG. 13 is a representation of a personalised welcome screen 1300 displayed to a user upon having entered a correct owner access code. Returning to FIG. 7, step 750 stores data relating to the delivery and collection and associated temperatures. The method 750 terminates at an End step 750.

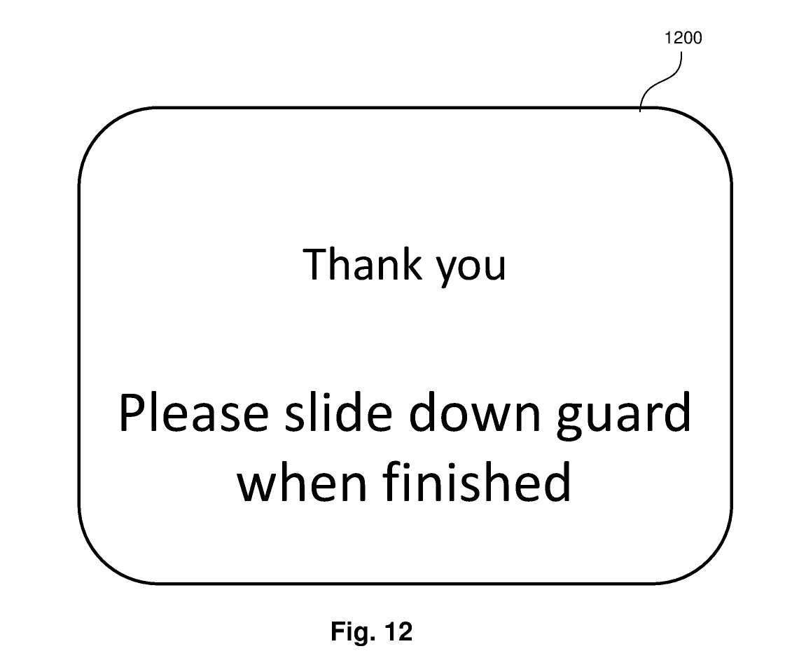

FIG. 12 is a closing screen 1200 displayed at the completion of a delivery or a collection. The closing screen 1200 instructs the delivery agent 240 or the user 210 to slide down a guard when finished. The guard protects the user interface 810 of the storage unit 250.

The delivery method and system of the present disclosure use a lockable storage unit to provide secure delivery of items with a documented trail of chain of ownership.

### INDUSTRIAL APPLICABILITY

The arrangements described are applicable to the retail, security, and delivery/fulfillment industries.

The foregoing describes only some embodiments of the present invention, and modifications and/or changes can be made thereto without departing from the scope and spirit of the invention, the embodiments being illustrative and not restrictive.

In the context of this specification, the word “comprising” and its associated grammatical constructions mean “including principally but not necessarily solely” or “having” or “including”, and not “consisting only of”. Variations of the word “comprising”, such as “comprise” and “comprises” have correspondingly varied meanings.

As used throughout this specification, unless otherwise specified, the use of ordinal adjectives “first”, “second”, “third”, “fourth”, etc., to describe common or related objects, indicates that reference is being made to different instances of those common or related objects, and is not intended to imply that the objects so described must be provided or positioned in a given order or sequence, either temporally, spatially, in ranking, or in any other manner.

Although the invention has been described with reference to specific examples, it will be appreciated by those skilled in the art that the invention may be embodied in many other forms.

1. A storage unit comprising:
a plurality of compartments including at least one refrigerated compartment, said refrigerated compartment being associated with a thermostat and a cooling device;
a corresponding plurality of scales, each compartment being associated with a scale;
a communications module for coupling to a communications network;
at least one lid for accessing said compartments;
a lock adapted to secure each said lid in a closed position;
a control panel for controlling said lock, said control panel having a user interface for receiving input from a user; and
a power source for supplying power to said cooling device and said control panel;
wherein the control panel is adapted to release said lock upon validating said received input against a code received by said communications module.

2. The storage unit according to claim 1, wherein said power source is an electrical connector for coupling to a mains power supply.

3. The storage unit according to claim 1, wherein said power source includes a battery.

4. The storage unit according to claim 1, wherein said user interface includes a keypad for receiving a Personal Identification Number (PIN).

5. The storage unit according to claim 1, wherein said communications module includes a wireless transceiver for wirelessly communicating via said communications network.

6. The storage unit according to claim 5, wherein said wireless transceiver is adapted to communicate using at least one of Wi-Fi, Bluetooth, 3G mobile telephony, or 4G mobile telephony.

7. The storage unit according to claim 5, wherein said communications module transmits delivery data in relation to delivered goods to a remote server via said communications network, wherein said delivery data includes at least one of delivery date, delivery time, weight of said delivered goods, and temperature of each said refrigerated compartment.

8. The storage unit according to claim 1, wherein said lock includes a release means adapted to be activated from within at least one of said compartments.

9. The storage unit according to claim 1, wherein said control panel is adapted to activate said lock to secure said lid when any one of said scales registers a non-zero weight and a predefined locking time period has elapsed.

10. The storage unit according to claim 1, wherein each said refrigerated compartment includes a thermometer for recording a temperature of said refrigerated compartment.

11. The storage unit according to claim 1, wherein said code is a delivery code entered by a delivery agent in relation to a delivery from a first retailer.

12. The storage unit according to claim 1, wherein said code is an owner access code associated with an owner of said storage unit.

13. A secure delivery storage system, comprising:
a server adapted to host a website, said server including:
at least one processor;
a memory for storing user data relating to a set of registered users and web site data relating to said website;
a logistics module for generating a delivery access code associated with a purchase made by one of said registered users; and
a server communications module coupled to a communications network for transmitting said delivery access code to a delivery agency; and
a storage unit for receiving a delivered product, said storage unit being associated with a registered user of said website, said storage unit including:
a first compartment;
first scales associated with said first compartment;
a storage unit communications module for coupling to said server communications module via said communications network;
a lid for accessing said first compartment;
a lock adapted to secure said lid in a closed position;
a control panel for controlling said lock, said control panel having a user interface for receiving said delivery access code; and
a power source for supplying power said control panel;
wherein said control panel releases said lock on receipt of said delivery access code, and
further wherein said storage unit communications module is adapted to transmit a delivery message to said website when said scales detect a delivery item in said first compartment.

14. The secure delivery storage system of claim 13, wherein said storage unit communications module is further adapted to transmit a delivery alert to said registered user associated with said purchase, upon detection of said delivery item.

15. The secure delivery storage system of claim 14, wherein said delivery alert is at least one of a Short Message Service (SMS) message and an email message.

16. The secure delivery storage system of claim 13, wherein said server allocates an owner access code to the registered user associated with said storage unit.

17. The secure delivery storage system of claim 13, wherein said storage unit is adapted to transmit delivery data, in relation to delivered goods, to said server via said communications network, wherein said delivery data includes at least one of delivery date, delivery time, weight of said delivered goods, and temperature of said delivered goods.

18. The secure delivery storage system of claim 13, further comprising:
a cooling device and thermostat associated with said first compartment, wherein said thermostat controls said cooling device to cool said first compartment to a predefined temperature range.

19. The secure delivery storage system of claim 18, further comprising a thermometer adapted to record a temperature of said compartment at periodic intervals and store said recorded temperatures in a log.

20. The secure delivery storage system according to claim 19, wherein said delivery message includes a recorded temperature of said first compartment at a time corresponding to detection of said delivery item.
